(19) United States
(12) Patent Application Publication
(10) Pub. No.: US 2007/0292590 A1
(43) Pub. Date: Dec. 20, 2007

(54) Dried Meat Products Including At Least One Stimulant

(76) Inventor: Brian Levin, Englewood, CO (US)

Correspondence Address: LEE & HAYES, PLLC, 421 W. RIVERSIDE AVE, STE 500, SPOKANE, WA, 99201, US

(21) Appl. No.: 11/692,819

(22) Filed: Mar. 28, 2007

Related U.S. Application Data
(60) Provisional application No. 60/743,932, filed on Mar. 29, 2006.

(51) Int. Cl. A23L 1/36; A23L 1/31; A23L 1/314; A23L 1/325

(52) U.S. Cl. 426/629

(57) ABSTRACT

An exemplary dried, meat-based product includes meat and plant seed where the plant seed comprises at least approximately 3% caffeine by weight. For example, an exemplary product includes guaraná plant seed. According to various products and processes, plant seed may be provided as a powder.

### RELATED APPLICATIONS

This application claims priority to pending U.S. Provisional Application Ser. No. 60/743,932, entitled “Dried Meat Products Including at Least One Stimulant”, filed Mar. 29, 2006, which is incorporated by reference herein.

### BACKGROUND

Beef jerky and other types of meat jerky have been on the market for years. Many consumers demand product innovations or are open to trying new products, as they appear on the market. Various new jerky products and processes are described herein.

### BRIEF DESCRIPTION OF THE DRAWINGS

Features and advantages of the described implementations can be more readily understood by reference to the following description taken in conjunction with the accompanying drawings.

FIG. 1 shows a top view and a side view of a package for an exemplary product.

FIG. 2 shows a top view and a side view of a package for an exemplary product.

### DETAILED DESCRIPTION

Exemplary products and processes are described herein. Exemplary products are meat-based, for example, beef veal, pork, lamb, mutton, goat, venison, buffalo, poultry (e.g., chicken, turkey, game bird), fish, etc. Products are generally muscle meat-based. Products may optionally include more than one type of meat. Packaged products may optionally include more than one type of meat.

As described herein, an exemplary product includes one or more compounds known to act as a stimulant. For example, caffeine, coffee, tea, taurine, maté and guaranà berries may be suitable for use as a compound or as a source of a compound. A compound may be synthetic or natural. Various exemplary processes are suitable for making exemplary meat-based products that include one or more exemplary compounds. Exemplary packages are also discussed.

Exemplary Compounds

Caffeine (sometimes called guaranine when found in guaraná, mateine when found in maté, and theine when found in tea) is a xanthine alkaloid found in the leaves and beans of the coffee tree, in tea, yerba maté, guaraná berries, and in small quantities in cocoa, the kola nut and the Yaupon holly. Caffeine is a stimulant of the central nervous system, cardiac muscle, and respiratory system. It is generally known as a diuretic and as delaying fatigue.

There are numerous compounds called alkaloids, among them are the methylxanthines, which include the compounds caffeine, theophylline, and theobromine. These compounds can be found in cola nuts, coffee, tea, cacao beans, maté and other plants. These compounds are present in different ratios in different plant sources and can have different biochemical effects. These compounds differ structurally by the presence of methyl groups in two positions. These compounds are easily oxidized to uric acid and other methyluric acids.

Theophylline is found in many teas and known to be a cardiac stimulant, smooth muscle relaxant, diuretic, and vasodilator. Theobromine is a principle alkaloid of cocoa beans (e.g., about 1.5% to about 3%), cola nuts and tea. Theobromine is known to be a diuretic, smooth muscle relaxant, cardiac stimulant and vasodilator.

Taurine is an amino acid formally known as 2-Aminoethanesulfonic Acid with the chemical formula: C₂H₇NO₃S. Some animals cannot synthesize sufficient taurine from other amino acids while other animals can synthesize taurine from the amino acids methionine and cystine. Taurine supplements are usually the result of synthesis by sodium sulfite sulfonation of ethylene chloride followed by ammonolysis with anhydrous NH₃ or with aqueous NH₃ and ammonium carbonate.

High concentrations of taurine are found in the heart muscle, skeletal muscles, brain and eyes of mammals, as well as the meat from clams and oysters. Taurine is sensitive to heat and taurine content in meat is greatly reduced after cooking. Table 1 shows taurine content for various types of cooking methods in relationship to uncooked muscle.

TABLE 1
Reduction in Taurine due to Heat Treatment

| | Uncooked | Baked | Boiled |
|---|---|---|---|
| | Mean | Mean | Mean |
| | (mg/kg wet) | (mg/kg wet) | (mg/kg wet) |
| Beef muscle | 362 | 133 | 60 |
| Lamb muscle | 473 | 257 | 126 |
| Chicken muscle | 337 | 229 | 82 |

Yerba matéor hierba maté (llex paraguariensis), or sometimes called simply “maté”, is a species of holly (family Aquifoliaceae) native to subtropical South America in northern Argentina, Paraguay, Uruguay and southern Brazil and Bolivia. Maté is often used as an herbal tea. As a tea, hot water (typically from about 70° C. to about 80° C.) is added to extract various compounds from the maté.

Maté contains xanthines (alkaloids in the same family as caffeine, theophylline, and theobromine), which are well-known stimulants. Xanthines are also found in coffee and chocolate. Maté also contains the chemical elements potassium, magnesium and manganese.

Some studies of maté indicate that the maté xanthine mixture acts differently from mixtures of other plants containing caffeine most significantly in its effects on muscle tissue, as opposed to those on the central nervous system, which are similar to those of other natural stimulants. Maté has been shown to have a relaxing effect on smooth muscle tissue and a stimulating effect on myocardial (heart) tissue.

Guaraná (Paullinia cupana; syn. P. crysan, P. sorbilis), is a shrub or small tree in the Sapindaceae family, native to Venezuela and northern Brazil. The seed of the guaraná fruit is a central nervous system stimulant with thermogenic and diuretic properties. The guaraná plant contains caffeine (sometimes called guaranine), theophylline, and theobromine. Water extracts of the guaraná plant are central nervous system stimulants.

Various guaraná compounds are found in the nut-shaped and eye-like seeds of Paullinia cupana and Paullnia sorbilis. These two plants are very similar and usually considered to be races of the same species (e.g., cupana and sorbilis may be considered synonymous). The high caffeine content of the seeds (e.g., about 2% to about 6%), is typically considered as responsible for the strong stimulating effect of guaraná beverages. Guaraná also contains quantities of theophylline and theobromine (e.g., lower quantities than caffeine). A large difference exists in the caffeine content of various tissues or organs of the fruits and seeds of guaraná. For example, the bulky, soft and mealy aril is completely devoid of any methylxanthines while caffeine content is highest in the cotyledons, the seeds (about 4.3%), and distinctly lower in the seed coats (about 1.6%). The septa contains about 0.7% caffeine and the pericarp only about 0.02%. Both theobromine and theophylline are minor alkaloids in all tissues, except for theobromine in the pericarp, where it is the main alkaloid (about 0.20%).

With respect to harvesting, the seeds are picked as soon as a few fruits open. The “white of the eye”, botanically an aril of mealy consistency, is typically rubbed off manually, and the seeds gently roasted to facilitate the removal of the glossy, tough, and dark brown seed coat. The kernels are then ground and crushed in a hard wood mortar and mixed with water into dough. This dough is then formed into long reddish-brown or brownish-black sticks (e.g. pasta-like) and dried to a nourishing food, well suited for storage in the hot and humid equatorial climate.

For use as a beverage, the pasta guaraná is powdered and the powder is prepared with hot or cold water, like cocoa, and sweetened. Owing to the high tannin content (e.g., about 2% to about 5%), the beverage is slightly bitter, astringent and acid; but it has no marked odor.

There can be some differences in processing of guaraná seeds for traditional and industrial use. For example, seed coats are typically removed prior to roasting during traditional procedures while they are typically retained in the powders obtained from industrial manufacturers. As described herein, the term “seed” refers to seed with or without seed coat, unless otherwise specified. Other differences can involve the roasting of seeds and the drying process of the guaraná paste.

Whereas guaraná seeds contain high amounts of caffeine and small quantities of theobromine and theophylline, the quantity of these methylxanthines in commercial products typically varies from sample to sample. Many of the products contain caffeine as the major alkaloid, with traces of theophylline and theobromine. From analytical studies, numerous sodas and syrups contained up to ten times more theobromine than caffeine, indicating that these products are possibly adulterated with cocoa, the major source of theobromine.

A method using supercritical carbon dioxide for extraction of caffeine from wet guaraná seeds has been developed that takes, for example, around 8 hours to extract most of the caffeine present in the seeds of smallest particle size, which is quicker than with conventional organic solvents presently used for decaffeination.

Another source for one or more compounds is the wild plant Paullinia yoco. A yoco beverage is traditionally not made with hot water but rather expressed sap that can allay hunger sensations and supply stimulation.

As explained herein, caffeine has a wide distribution within the plant kingdom (e.g., coffee beans (Coffea arabica), tea leaves (Camellia sinensis), leaves of llex paraguariensis (maté), guaraná paste (Paullinia cupana), kola nuts (Cola acuminata), etc.). Caffeine has been found in many other plants, mainly members of the Dicotyledoneae. Altogether it is produced by a large number of species belonging to at least twenty-eight genera over seventeen families in thirteen orders of plants.

The highest number (twenty) of caffeine-containing species is found within the family Sterculiaceae, where the most important plants are Cola acuminata and Theobroma cacao. Certain plant parts contain more than 1% of caffeine on a dry weight basis. This situation occurs in the leaves of the llex (Aquifoliaceae) and Camellia (Theaceae) species, in seeds from the Coffea (Rubiaceae), Cola (Sterculiaceae) and Paullinia (Sapindaceae) species, and in the bark of Paulilinia yoco. According to some studies, the highest content of caffeine in plants is found in seeds from the plants Paullinia cupana and Paullinia sorbilis, which may contain as much as about 6% caffeine, or more. Again, these plants are often considered to be races of the same species. Based on dry weight, the highest amounts of caffeine are found in guaraná (approximately 4% to 6%) while tea leaves contain approximately 3.5% caffeine, coffee beans about 1.1% to approximately 2.2% caffeine, cola nuts approximately 1.5% caffeine and cacao beans approximately 0.03% caffeine. Cacao beans in addition contain approximately 1.8% to approximately 2.5% theobromine.

Exemplary Processes

An exemplary process adds one or more of the aforementioned compounds to a meat product. The point or points of addition in such a process can vary. For example, a compound may be a component of a marinade and thus added prior to drying the meat product. In another example, a compound is added after at least some degree of drying a meat product.

Where an exemplary compound has sensitivity to temperature or other environmental conditions (e.g., pH, moisture, etc.), a process may add the compound in a manner that aims to preserve activity of the compound. For example, an exemplary process adds taurine to muscle at a point in a process where the muscle will not experience elevated temperatures for a period of time that could result in destruction of the taurine. For example, boiling has an ability to greatly reduce taurine content of muscle. If additional taurine was added prior to such heat treatment (i.e., boiling), then a reduction could be expected. Hence, an exemplary process adds taurine once high temperature processing (e.g., about 100° C.) has ceased and optionally where the muscle has cooled substantially.

An exemplary compound may be added at various points in a process to bring the concentration or activity to a final desirable level.

An exemplary process may include one or more steps used in conventional production of “jerky” products (e.g., beef jerky, etc.). Various conventional jerky processes use a marinade to season meat. An exemplary process may use a marinade and/or other seasoning, flavoring or ingredient adding procedures.

Table 2 presents an example of a marinade. Such an example may be used with other ingredients or various ingredients may be omitted. With respect to one or more exemplary compounds, the example of Table 2 includes caffeine. Other examples may include one or more other exemplary compounds as alternatives or in addition to caffeine.

TABLE 2
Example Marinade

| Ingredient | Amount | Percentage |
|---|---|---|
| WORCESTERSHIRE SAUCE | 8.36 | 27.85% |
| TAMARI SOY SAUCE | 9.55 | 31.82% |
| HONEY, CLOVER | 3.58 | 11.93% |
| PEPPER, BLACK, CRACKED 20 | 0.27 | 0.91% |
| ONIONS, GRANULATED | 0.36 | 1.19% |
| LIQUID SMOKE, RED ARROW, CHARSOL H-10 | 0.32 | 1.06% |
| RED PEPPER, CRUSHED 6 | 0.06 | 0.21% |
| DARK BROWN SUGAR, C&H | 4.18 | 13.92% |
| GARLIC, GRANULATED | 0.19 | 0.64% |
| BEEF FLAVOR CONC. | 0.72 | 2.39% |
| CAFFEINE | 0.09 | 0.30% |
| e.g., extracted from natural source or synthetic | | |
| GINGER, FRESH, SKIN ON, CHOPPED 1/16″ | 2.33 | 7.76% |
| TOTAL | 30.00 | |

Example Process

In an example of a beef-based product, wholly denuded top round cuts of meat, USDA choice or good are provided and the top rounds are cut into strip pieces approximately 2½ inch×1½ inch× 3/16 inch thick (e.g., approximately 6.4 cm×3.8 cm×0.5 cm).

One or more pre-mixes are optionally made. For example, an exemplary compound is optionally a component in a pre-mix to facilitate distribution or to provide for some protection from other chemicals or environmental factors.

An exemplary marinade, such as in the example above, is created in the following order: Worcestershire sauce, soy sauce, honey, and brown sugar are mixed well together. Remaining ingredients are added, and then mixed well. A marinade may be hand mixed and/or machine mixed.

Treatment of meat may occur in any of a variety of manners. For example, after preparation of a marinade, a manual soak or a vacuum tumble may be used. In a manual soak, meat is placed in marinade mix and soaked overnight. In a vacuum tumble, meat is placed in vacuum tumbler with the marinade and vacuum tumbled for approximately 30 min at 15-20 RPM.

With respect to temperature, the marinade and meat may be combined and stored at approximately 40° F. (e.g., less than about 5° C.). The meat may be stored and marinated for 16-24 hours for the manual process. For the vacuum tumbler the time may be shortened considerably, e.g., marinating duration of about 30 minutes may suffice.

After marination is complete, the meat is removed (or otherwise separated) from the marinade and the excess marinade is allowed to drain off the meat. Where a smoker is used, the meat is placed on screens and placed in the smoker and smoked for about 4 hours at about 170° F. (e.g., about 80° C.). For the first hour of smoking, the humidity of the smoker is about 90% while for the remaining time dry heat is used. After smoking, the product is stored in a refrigerator at about 5° C. for about 12 hours.

After storing, packaging may occur. An exemplary process weighs product into about 2 ounce servings (about 60 g), and then placed in a tin packing container. The container may be sealed and shrink banded. The sealed containers may be further packaged into a case or a point-of-purchase display.

Example Process

Tumble beef and ingredients inside a tumbler with vacuum for approximately 4 minutes. Transfer seasoned meat on to polyethylene nets and dry for approximately 3 hours and 45 minutes with the following temperature-time profile:
1) 130° F. (˜54° C.) for 15 minutes;
2) 150° F. (˜65° C.) for 15 minutes; and
3) 170° F. (˜77° C.) for 3 hours and 15 minutes.

Take meat out of the ovens, let it cool and remove from plastic nets. Cut processed beef into 2 inch by 2 inch strips (e.g., approx. 5 cm×5 cm) and pack in cans (e.g., tin) with oxygen absorber. For example, a filled can may have a net weight of approximately 2 ounces (˜56 g). A processed beef product may have a moisture protein ratio (MPR) of approximately 0.75:1.

TABLE 3
Example Product

| Ingredient | Percentage |
|---|---|
| BEEF | 80.89% |
| SOY SAUCE | 8.90% |
| (water, wheat, soybeans, salt) | |
| WORCESTERSHIRE SAUCE | 5.66% |
| (vinegar, molasses, high fructose corn sugar, | |
| anchovies, water, onions, salt, garlic, | |
| tamarind concentrate, cloves, natural flavorings, | |
| chili pepper extract) | |
| BROWN SUGAR | 1.40% |
| HONEY | 0.94% |
| GINGER | 0.87% |
| GUARANA SEED POWDER | 0.57% |
| BEEF FLAVOR | 0.25% |
| (beef, yeast extract, salt, soy sauce, | |
| water, wheat, soybeans, salt) | |
| GRANULATED ONIONS | 0.24% |
| BLACK PEPPER | 0.13% |
| GRANULATED GARLIC | 0.10% |
| RED CHILI PEPPER | 0.04% |

In the above example product, various ingredients may be combined in a marinade while one or more other ingredients may be added prior to marinade and/or after marinade. With respect to chili pepper, any of a variety of chili pepper may be used (e.g., fruit from the genus Capsicum of the family Solanaceae). For example, Capsicum annuum, which includes many common varieties such as bell peppers, paprika, jalapenos, and the chiltepin; Capsicum frutescens, which includes the cayenne and tabasco peppers; Capsicum chinense, which includes the hottest peppers such as the naga, habanero and Scotch bonnet; Capsicum pubescens, which includes the South American rocoto peppers and/or Capsicum baccatum, which includes the South American aji peppers may be used. As an alternative, or in addition to, the substance capsaicin may be used for a product (and/or other capsaicinoids such as dihydrocapsaicin, nordihydrocapsaicin, homodihydrocapsaicin, and homocapsaicin). An exemplary product may include a substance such as allyl isothiocynanate (e.g., mustard oil as found in horse radish and other plants). Substances such as capsaicinoids and allyl isothiocynanate can be used to cause sensations upon ingestion or even smelling a product.

An exemplary dried, meat-based product includes meat and guaraná seed powder. Such a product may also include chili pepper. With respect to the powder, the product may include approximately 0.1% to approximately 3% guaraná seed powder by weight. As described above, a particular example includes approximately 0.5% guaraná seed powder by weight. In general, an exemplary product may include more or less guaraná by weight, whether as a powder, paste, extract, etc. As already mentioned, guaraná seeds have a fairly high concentration of caffeine, hence, as a natural ingredient, some efficiency may be gained through use of guaraná seed. For example, while a coffee bean may have approximately 2% caffeine by weight, guaraná seed typically has more. An exemplary process may use guaraná seed that includes at least approximately 3% caffeine by weight and an exemplary product may include guaraná seed that includes at least approximately 3% caffeine by weight. As already mentioned, a meat-based product may be beef, poultry and/or seafood.

An exemplary dried, meat-based product includes meat and plant seed wherein the plant seed comprises at least approximately 3% caffeine by weight. As already mentioned, such plant seed may be with or without seed coat, noting that the seed coat typically has less caffeine by weight than the seed (e.g., cotyledons, etc.) contained by the coat. In such an example, the plant seed may be seed of the plant Paullinia cupana and/or the plant Paullinia sorbilis. An exemplary dried, meat-based product may include approximately 0.1% to approximately 3% of plant seed by weight. In a particular example, a product includes approximately 0.5% seed by weight. Plant seed may be in the form of powdered plant seed and/or other form. Plant seed may include between approximately 3% and approximately 6% caffeine by weight. As already mentioned, a meat-based product may be beef poultry and/or seafood.

An exemplary method includes providing beef (and/or other meat), providing liquid that includes one or more seasonings (e.g., a marinade or marinades), providing plant seed powder where the plant seed powder comprises caffeine; mixing the beef, the liquid and the plant seed powder under vacuum to treat the beef and drying the treated beef to produce dried, treated beef. In such an example, the drying may use a multi-stage temperature-time profile. For example, a process may use a first stage at approximately 130° F. (˜54° C.) for approximately 15 minutes, a second stage at approximately 150° F. (˜65° C.) for approximately 15 minutes and a third stage at approximately 170° F. (˜77° C.) for approximately 3 hours and 15 minutes. After drying, packaging of the dried, treated beef may occur. Dried, treated beef may have a moisture protein ratio (MPR) of approximately 0.75:1. An exemplary treated meat-based product may have a lesser or greater moisture protein ratio.

Exemplary Packaging

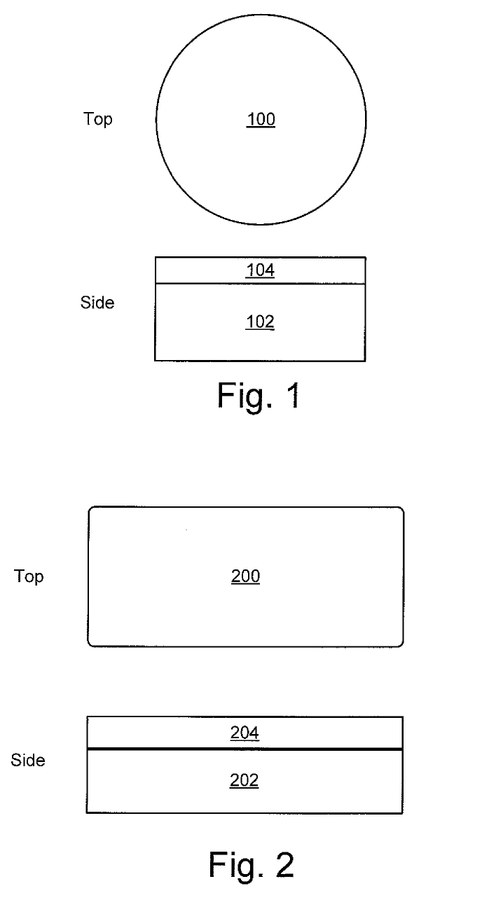

FIG. 1 shows a top view and a side view of a package 100 for an exemplary product. The package includes a receptacle 102 and a lid 104 where the receptacle 102 receives the lid 104 to thereby enclose product inside the package. A press fit or screw mechanism may be used to secure the lid 104 to the receptacle 102. An exemplary package optionally includes a hinge to link the lid 104 and the receptacle 102.

FIG. 2 shows a top view and a side view of a package 200 for an exemplary product. The package includes a receptacle 202 and a lid 204 where the receptacle 202 receives the lid 204 to thereby enclose product inside the package. A press fit or screw mechanism may be used to secure the lid 204 to the receptacle 202. An exemplary package optionally includes a hinge to link the lid 204 and the receptacle 202.

An exemplary package may be of any suitable dimension. For example, a package may be of dimensions suitable for carrying in a pants pocket, a shirt pocket, a jacket pocket, etc. (e.g., largest diameter typically less than about 10 cm). An exemplary package may be of larger dimension depending on the particular use.

The package 100 or the package 200 may be suitable used as the aforementioned in a tin packing container (e.g., to contain about 60 g of product).

1. A dried, meat-based product comprising:
meat; and
guaraná seed powder.

2. The product of claim 1 further comprising chili pepper.

3. The product of claim 1 comprising approximately 0.1% to approximately 3% guaraná seed powder by weight.

4. The product of claim 1 comprising approximately 0.5% guaraná seed powder by weight.

5. The product of claim 1 wherein the meat comprises beef.

6. The product of claim 1 wherein the meat comprises poultry.

7. The product of claim 1 wherein the meat comprises seafood.

8. The product of claim 1 wherein the guaraná seed powder comprises caffeine.

9. The product of claim 8 wherein the guaraná seed powder comprises at least approximately 3% caffeine by weight.

10. A dried, meat-based product comprising:
meat; and
plant seed wherein the plant seed comprises at least approximately 3% caffeine by weight.

11. The product of claim 10 wherein the plant seed comprises seed of the plant Paullinia cupana.

12. The product of claim 10 wherein the plant seed comprises seed of the plant Paullinia sorbilis.

13. The product of claim 10 comprising approximately 0.1% to approximately 3% of plant seed by weight.

14. The product of claim 10 comprising approximately 0.5% seed by weight.

15. The product of claim 10 wherein the plant seed comprises powdered plant seed.

16. The product of claim 10 wherein the plant seed comprises between approximately 3% and approximately 6% caffeine by weight.

17. The product of claim 10 wherein the meat comprises beef.

18. The product of claim 10 wherein the meat comprises poultry.

19. The product of claim 10 wherein the meat comprises seafood.

20. A method comprising:
providing beef;
providing liquid that comprises one or more seasonings;
providing plant seed powder wherein the plant seed powder comprises caffeine;
mixing the beef, the liquid and the plant seed powder under vacuum to treat the beef; and
drying the treated beef to produce dried, treated beef.

21. The method of claim 20 wherein the drying comprises a multi-stage temperature-time profile.

22. The method of claim 20 wherein the multi-stage temperature-time profile comprises:
a first stage at approximately 130° F. (˜54° C.) for approximately 15 minutes;
a second stage at approximately 150° F. (˜65° C.) for approximately 15 minutes; and
a third stage at approximately 170° F. (˜77° C.) for approximately 3 hours and 15 minutes.

23. The method of claim 20 further comprising packaging the beef.

24. The method of claim 20 wherein the dried, treated beef comprises a moisture protein ratio of approximately 0.75:1.
